(19) United States
(12) Patent Application Publication
(10) Pub. No.: US 2025/0286319 A1
(43) Pub. Date: Sep. 11, 2025

(54) Quick Disconnect Terminal With Split Mating Interface

(71) Applicant: TE Connectivity Solutions GmbH, Schaffhausen (CH)

(72) Inventors: Eric M. SHERBOCKER, Middletown, PA (US); Tyler BLAIR, Middletown, PA (US); William James Moyer, II, Selingrove, PA (US); Michael Christopher D'Imperio, Lancaster, PA (US)

(73) Assignee: TE Connectivity Solutions GmbH, Schaffhausen (CH)

(21) Appl. No.: 18/599,351

(22) Filed: Mar. 8, 2024

(51) Int. Cl. H01R 13/631; H01R 13/115; H01R 13/187

(52) U.S. Cl. CPC H01R 13/631; H01R 13/115; H01R 13/187

(57) ABSTRACT

An electrical terminal with a contact portion that has a bottom wall with resilient contact arms extending therefrom. A mating slot is positioned between the resilient contact and the bottom wall. The bottom wall has a split mating interface with a first section, a second section and a third section. The second section is separated from the first section by a first slot. The third section separated from the second section by a second slot. The first section, the second section and the third section move independently relative to each other in a direction perpendicular to an axis of insertion of a mating terminal to provide and maintain a stable and reliable electrical connection between a mating terminal inserted into the mating slot and the terminal.

### FIELD OF THE INVENTION

The present invention is directed to a quick connect electrical terminal. In particular, the invention is directed to a receptacle which minimizes stubbing of a mating electrical terminal and which provides a stable electrical connection even when the mating terminal is misaligned.

### BACKGROUND OF THE INVENTION

Quick connect electrical terminals, such as tab receptacle terminals, which are adapted for quick make and break connections with a mating terminal or mating tab, are known. Terminals of this kind are used to make an electrical connection to a male or tab terminal which is inserted and held in the socket terminal.

It is often necessary to disconnect and reconnect such terminals a number of times, for example, for testing purposes prior to final inspection and shipment of the product on which such terminals are used. It is also required that the connection made with such terminals be maintained under conditions of vibration and possible strain in subsequent service. Traditionally, these terminals have limited flexibility or movement which causes stubbing and high insertion forces. In addition, the contact areas of the terminals may be imbalanced resulting in an unstable electrical connection and a lesser current carrying capability.

It would, therefore, be beneficial to provide a quick connect receptacle terminal in which the mating interface provides sufficient flexibility to avoid stubbing and potential damage to the mating terminal. In addition, it would be beneficial to provide a receptacle terminal in which the mating interface is allowed to move with the mating terminal to provide a more stable electrical connection.

### SUMMARY OF THE INVENTION

An embodiment is directed to an electrical terminal with a contact portion that has a bottom wall with resilient contact arms extending therefrom. The bottom wall has a first section, a second section and a third section. The first section is separated from the second section by a first slot. The second section is separated from the third section by a second slot. The first section, the second section and the third section move independently relative to each other in a direction perpendicular to an axis of insertion of a mating terminal.

An embodiment is directed to an electrical terminal with a contact portion that has a bottom wall with resilient contact arms extending therefrom. A mating slot is positioned between the resilient contact and the bottom wall. The bottom wall has a split mating interface with a first section, a second section and a third section. The second section is separated from the first section by a first slot. The third section separated from the second section by a second slot. The first section, the second section and the third section move independently relative to each other in a direction perpendicular to an axis of insertion of a mating terminal to provide and maintain a stable and reliable electrical connection between a mating terminal inserted into the mating slot and the terminal.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is perspective view of an illustrative embodiment of a receptacle terminal according to the present invention, a mating tab terminal is shown prior to being inserted into the receptacle terminal.

FIG. 2 is a top view of the receptacle terminal of FIG. 1.

FIG. 3 is a bottom view of the receptacle terminal of FIG. 1.

FIG. 4 is a front view of the receptacle terminal of FIG. 1 prior to the mating tab terminal being inserted into a terminal receiving area of the receptacle terminal.

FIG. 5 is a front view of the receptacle terminal of FIG. 1, with the mating tab terminal inserted into the terminal receiving area of the receptacle terminal, the tab terminal is slightly misaligned with the receptacle terminal, causing the mating interface of the receptacle terminal to be flexed to accommodate the tab terminal.

FIG. 6 top view of a several receptacle terminals shown in a strip.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

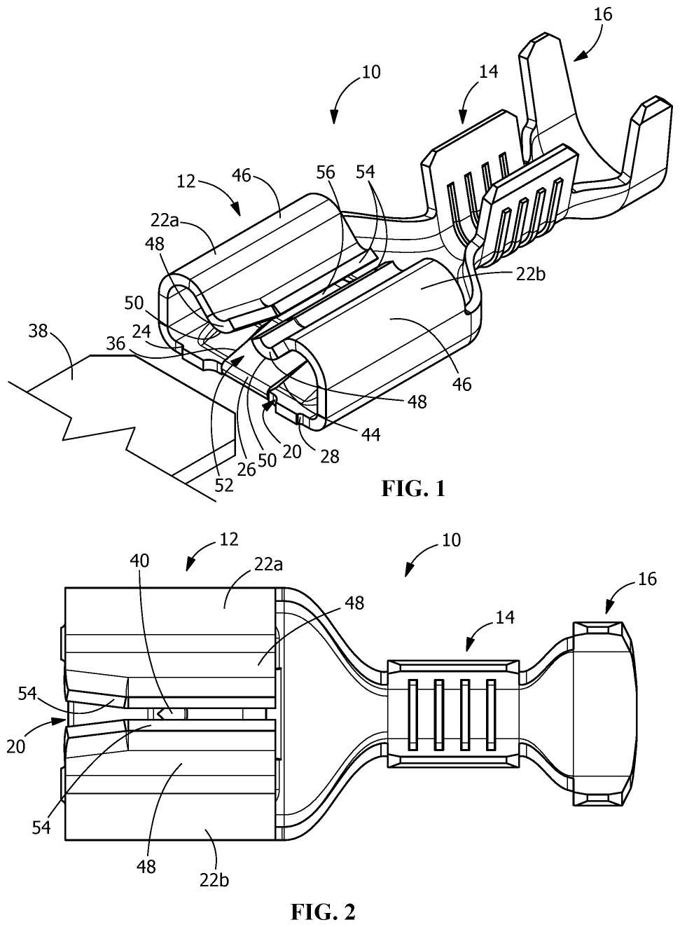

As best shown in FIGS. 1 through 5, a quick disconnect electrical receptacle, socket or female terminal 10 includes a contact portion 12, a wire barrel portion 14 behind the contact portion 12 and an insulation barrel portion 16 behind the wire barrel portion 14. The wire barrel portion 14 is configured for a crimped connection with an end of a conductive core of an insulated wire. The insulation barrel portion 16 is configured for a crimped connection with an end of the insulation coating or jacket of the wire. Although a wire barrel portion 14 and an insulation barrel portion 16 are shown, the contact portion 12 can be used with other types of termination members without departing from the scope of the invention. In the illustrative embodiment shown, the terminal 10 is stamped and formed from a metal plate having good electrical conductivity.

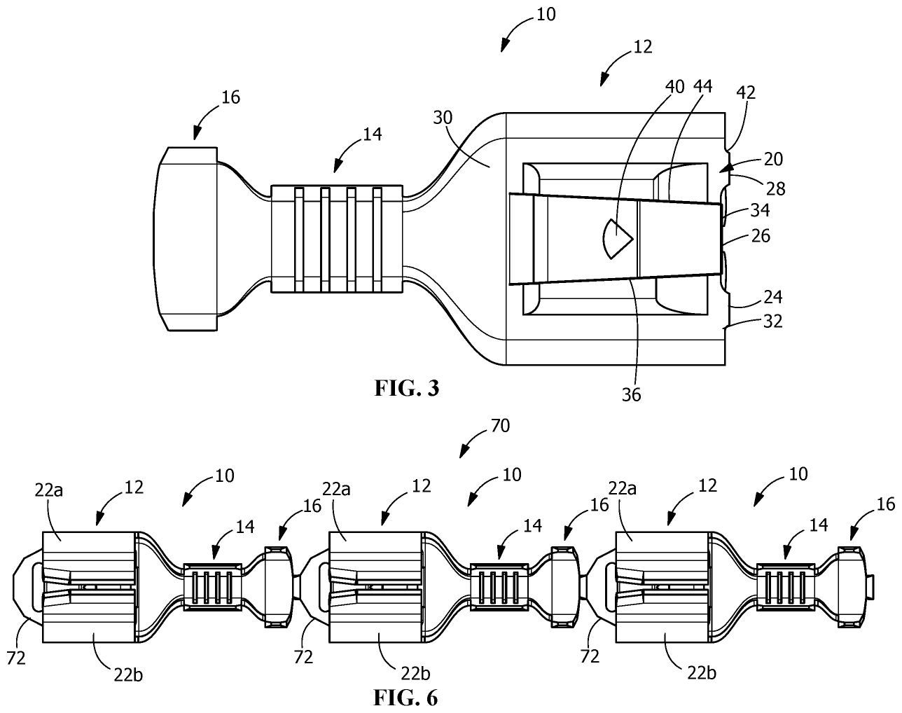

The contact portion 12 includes a bottom wall 20 and resilient contact arms 22a, 22b which extend from either side of the bottom wall 20. As shown in FIG. 3, the bottom wall 20 has a first section 24, a second section or spring arm 26 and a third section 28. The first section 24, the second section 26 and the third section 28 extend from, and are integrally attached to, a base section 30 of the bottom wall 20. The base section 30 is provided proximate the wire barrel portion 14. The first section 24, the second section 26 and the third section 28 form a split beam mating interface.

The first section 24 extends from base section 30 to a free end 32. The resilient contact arm 22a extends from the side of the first section 24.

The second section 26 extends from base section 30 to a free end 34. The second section 26 is separated from the first section 24 by a slot or gap 36. The slot or gap 36 allows the free end 34 of the second section 26 to move independently relative to the free end 32 of the first section 24 in a direction perpendicular to the axis of insertion of a mating terminal 38 (FIGS. 1 and 5) in the contact portion 12 of the terminal 10. The second section 26 has a projection or embossment 40, such as, but not limited to, a projection, detent, dimple or lance which is formed from the second section 26 to create a raised area on an inner surface of the second section 26. The projection or embossment 40 engages the mating terminal 38 as the mating terminal 38 is inserted into the terminal 10.

The third section 28 extends from base section 30 to a free end 42. The resilient contact arm 22b extends from the side of the third section 28. The third section 28 is separated from the second section 26 by a slot or gap 44. The slot or gap 44 allows the free end 42 of the third section 28 to move independently relative to the free end 34 of the second section 26 and relative to the free end 32 of the first section 24 in a direction perpendicular to the axis of insertion of the mating terminal 38 (FIGS. 1 and 5) in the contact portion 12 of the terminal 10.

In the illustrative embodiment shown in FIG. 1, each resilient arm 22a, 22b has a resilient contact section 46 with an arcuate or curled portion which extends from the bottom wall 20 to a mating terminal engaging member 48. The configuration of the resilient contact arms 22a, 22b allows the stiffness and spring rate of the resilient contact arms 22a, 22b to be controlled.

The mating terminal engagement members 48 extend from the resilient contact section 46. A mating terminal engagement surface 50 is provided on each mating terminal engaging member 48. In the embodiment shown, the mating terminal engaging member 48 extends from the resilient contact arms 22a, 22b, positioning the mating terminal engagement surface 50 at the top of a terminal mating slot 52. The configuration of the resilient contact arms 22a, 22b provides resiliency to allow the mating terminal engaging member 48 to move relative to the bottom wall 20 as the mating terminal is inserted into the mating slot 52. The mating terminal engagement surfaces 50 have an arcuate or rounded configuration. However, other configurations of the engagement surfaces 50 may be used.

The mating terminal engagement members 48 have end surfaces 54 which are positioned proximate to each other, but are spaced apart to form a slot 56. The width of the slot 56 is large enough to allow the end surfaces 54 and their respective contact arms 22a, 22b to move independently of each other. However, the width of the slot 56 is minimized to increase the beam length of the contact arms 22a, 22b. The beam length allows the contact arms 22a, 22b to have enhanced resilient or spring characteristics, allowing the contact arms 22a, 22b to move without taking a permanent set, failing or yielding. The slot 56 is positioned in line with the projection or embossment 40 of the second portion 26 of the bottom wall 20.

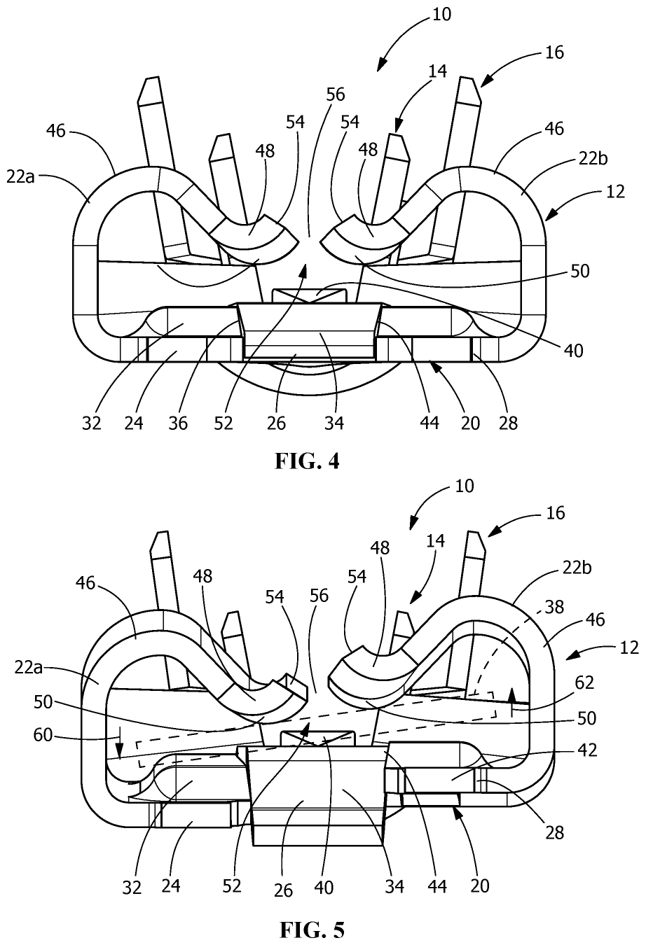

As shown in FIG. 4, in the initial, unstressed position, prior to the insertion of the mating terminal 38 into the mating slot 52, the embossment 40 of the second section or spring arm 26 is positioned proximate to, but not in engagement with, the mating terminal engagement surfaces 50 of the mating terminal engagement members 48. In this unstressed position, the resilient arm 22a and the resilient arm 22b are essentially mirror images of each other. The mating terminal engagement surfaces 50 of the mating terminal engagement members 48 are positioned in essentially the same plane which is transverse to the longitudinal axis of the terminal 10.

In the unstressed position, the mating terminal engagement surfaces 50 of the mating terminal engagement members 48 and the second section or spring arm 26 defined the mating slot 52. In this position, the resilient arms 22a, 22b are in an unstressed position. Similarly, the first section 24, the second section or spring arm 26 and the third section 28 are also in an unstressed position, allowing the free end 32 of the first section 24, the free end 34 of the second section 26, and the free end 42 of the third section 28 to be positioned essentially in line with each other.

As previously described, the slot 36 and the slot 44 provided in the bottom wall 20 allow the first section 24, the second section or spring arm 26 and the third section 28 to move independently of each other. Consequently, during insertion of the mating terminal 38 into the mating slot 52 of the contact portion 12 of the terminal 10, the contact portion 12, including the split mating interface of the first section 24, the second section 26 and the third section 28, may conform or adapt to a mating terminal 38 which is misaligned during mating, as shown in FIG. 5.

As shown in the illustrative embodiment of FIG. 5, the first section 24 and the resilient arm 22a attached thereto are moved downward, as represented by arrow 60, relative to the second section 26. In addition, the third section 28 and the resilient arm 22b attached thereto are moved upward, as represented by arrow 62, relative to the second section 26. This allows the contact section 12 to accommodate a mating terminal 38 which is misaligned in the manner shown in FIG. 5. However, if the orientation of the misaligned mating terminal 38 is different, the first section 24 and the resilient arm 22a may be moved upward and the third section 28 and the resilient arm 22b may be moved downward.

The relative independent movement of the first section 24, the second section or spring arm 26 and the third section 28 allow for the contact portion 12 of the terminal 10 to compensate for any slight misalignment of the mating terminal 38 or any slight warpage or imperfections associated with the mating terminal 38.

In a fully inserted position, the mating terminal engagement surface 50 of each of the resilient arms 22a, 22b are provided and maintained in physical and electrical engagement with the mating terminal 38. Due to the independent movement of the first section 24 and the third section 28, multiple points of contact are made and maintained between each mating terminal engagement surface 50 and the mating terminal 38. In addition, the embossment 40 or the second section or spring arm 26 is also provided and maintained in electrical and mechanical contact with the mating terminal 38. The multiple areas of contact allow the terminal 10 to be used in applications with higher current levels, such as, but not limited to, 15 to 20 or more amps.

The independent movement of the first section 24, the second section or spring arm 26 and the third section 28 provide and maintains a stable and reliable electrical connection between the mating terminal 38 and the terminal 10. The independent movement of the first section 24, the second section or spring arm 26 and the third section 28 also allows for higher hertzian stresses when the mating terminal 38 is mated to the terminal 10, thereby eliminating or minimizing the fretting corrosion between the terminal 10 and the mating terminal 38, further contributing to a stable and reliable electrical connection between the mating terminal 38 and the terminal 10.

Portions of the mating terminal engagement surfaces 50 are spaced from and are laterally offset from the embossment 40, allowing the engagement between the mating terminal 38 and the mating terminal engagement surfaces 50 and the embossment 40 of the terminal 10 to be dispersed, i.e. not at one point or in a straight line. This provides a stable mechanical and electrical engagement between the mating terminal 38 and receptacle terminal 10 in all environments, thereby insuring that the mating terminal 38 will remain properly positioned in the receptacle terminal 10 as vibration occurs or if the mating terminal 38 is bent.

A terminal according to the teaching of the invention has a lower spring rate than known terminals. As the first section 24, the second section or spring arm 26 and the third section 28 move independently, the resilient arms 22a, 22b can have a reduced spring rate while still providing sufficient normal force to retain the mating terminal 38 in the mating slot 52 of the contact portion 12 of the terminal 10. By controlling the spring rate of the spring arms 22a, 22b, the normal forces and insertion forces associated with the contact portion 12 of the terminal 10 can also be controlled, while allowing for a proper electrical connection between the terminals 10 and the mating terminals. For example, the insertion force of a terminal 10 made according to the present invention may be reduced in comparison to a terminal which has the first section 24, the second section or spring arm 26 and the third section 28 fixed to each other.

As the spring rate is reduced, the resilient arms 22a, 22b allow for a greater spring deflection before yielding or taking a permanent set. This allows the terminal 10 to be used with mating terminals 38 which have some variance in manufacturing tolerances. In other words, because the resilient arms 22a, 22b have the ability to deflect a greater distance without yielding or taking a permanent set, the thickness of the mating terminal 38 does not have be as precisely controlled. This is advantageous with terminals made of materials, such as steel, which do not exhibit generally poor spring characteristics.

Referring to FIG. 6, a portion of an illustrative strip 70 of terminals 10 are shown. A rigid front bar 72 is provide between each terminal 10 on the strip 10. The rigid front bar 72 is stamped and formed as the terminals 10 are stamped and formed. The rigid front bar 72 prevent damage to the terminals 10 during the reeling, plating and shipping of the terminals 10 and strip 70. The rigid front bar 72 is integrally attached to the bottom wall 20. The rigid front bar 72 extends from the first section 24 to the third section 28 of the bottom wall 20. The rigid front bar 72 cooperates with the first section 24 and the third section 28 to maintain the first section 24 and the third section 28 in a relatively fixed position relative to each other.

In the illustrative embodiment shown, the rigid front bar 72 is sheared off when a terminal 10 is terminated or crimped to a wire or cable. With the rigid front bar 72 removed the first section 24, second section 26 and third section 28 are allowed to move relative to each other as described above.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An electrical terminal comprising:
a contact portion having a bottom wall with resilient contact arms extending therefrom;
the bottom wall having a first section, a second section and a third section, the first section separated from the second section by a first slot, the second section separated from the third section by a second slot;
wherein the first section, the second section and the third section move independently relative to one another in a direction perpendicular to an axis of insertion of a mating terminal.

2. The electrical terminal as recited in claim 1, wherein a first resilient contact arm of the resilient contact arms extends from the first section of the bottom wall and a second resilient contact arm of the resilient contact arms extends from the third section of the bottom wall.

3. The electrical terminal as recited in claim 1, wherein the second section is a spring arm.

4. The electrical terminal as recited in claim 3, wherein an embossment is provided on the second section.

5. The electrical terminal as recited in claim 1, wherein the first section, the second section and the third section extend from, and are integrally attached to a base section of the bottom wall.

6. The electrical terminal as recited in claim 1, wherein the first section extends from a base section of the bottom wall to a first free end, a first resilient contact arm extends from the first section.

7. The electrical terminal as recited in claim 6, wherein the second section extends from the base section to a second free end, the second free end of the second section moves independently relative to the first free end of the first section in a direction perpendicular to the axis of insertion of the mating terminal, the second section has an embossment formed from the second section to create a raised area on an inner surface of the second section.

8. The electrical terminal as recited in claim 7, wherein the third section extends from the base section to a third free end, a second resilient contact arm extends from the third section, the third free end of the third section moves independently relative to the first free end of the first section and the second free end of the second section in a direction perpendicular to the axis of insertion of the mating terminal.

9. The electrical terminal as recited in claim 8, wherein the first resilient arm and the second resilient arm have resilient contact sections with arcuate portions which extend from the bottom wall to mating terminal engaging members.

10. The electrical terminal as recited in claim 9, wherein mating terminal engagement surfaces are provided on the mating terminal engaging members, the mating terminal engagement surfaces are positioned at a top of a terminal mating slot.

11. The electrical terminal as recited in claim 10, wherein the mating terminal engagement members have end surfaces which are positioned proximate to each other, but are spaced apart to form a slot, the ends surfaces and their respective contact arms move independently of each other.

12. The electrical terminal as recited in claim 1, wherein the contact portion is moveable between a first position and a second position, in the first position, prior to the insertion of the mating terminal into a mating slot of the contact portion, the contact portion is in an unstressed position, in the second position, with the mating terminal inserted into the mating slot of the contact portion, the contact portion is in a stressed position.

13. An electrical terminal comprising:
a contact portion having a bottom wall with resilient contact arms extending therefrom, a mating slot positioned between the resilient contact and the bottom wall;
the bottom wall having a split mating interface comprising:
a first section;
a second section separated from the first section by a first slot;
a third section separated from the second section by a second slot;
wherein the first section, the second section and the third section move independently relative to one another in a direction perpendicular to an axis of insertion of a mating terminal to provide and maintain a stable and reliable electrical connection between a mating terminal inserted into the mating slot and the terminal.

14. The electrical terminal as recited in claim 13, wherein a first resilient contact arm of the resilient contact arms extends from the first section of the bottom wall and a second resilient contact arm of the resilient contact arms extends from the third section of the bottom wall.

15. The electrical terminal as recited in claim 13, wherein the second section is a spring arm.

16. The electrical terminal as recited in claim 13, wherein the first section, the second section and the third section extend from, and are integrally attached to a base section of the bottom wall.

17. The electrical terminal as recited in claim 13, wherein the first section extends from a base section of the bottom wall to a first free end, a first resilient contact arm extends from the first section.

18. The electrical terminal as recited in claim 17, wherein the second section extends from the base section to a second free end, the second free end of the second section moves independently relative to the first free end of the first section in a direction perpendicular to the axis of insertion of the mating terminal, the second section has an embossment formed from the second section to create a raised area on an inner surface of the second section.

19. The electrical terminal as recited in claim 18, wherein the third section extends from the base section to a third free end, a second resilient contact arm extends from the third section, the third free end of the third section moves independently relative to the first free end of the first section and the second free end of the second section in a direction perpendicular to the axis of insertion of the mating terminal.

20. The electrical terminal as recited in claim 19, wherein the first resilient arm and the second resilient arm have resilient contact sections with arcuate portions which extend from the bottom wall to mating terminal engaging members.
